(19) United States
(12) Patent Application Publication
(10) Pub. No.: US 2022/0404154 A1
(43) Pub. Date: Dec. 22, 2022

(54) METHOD AND DEVICE FOR DETERMINING EMERGENCY TRAJECTORIES AND FOR OPERATING AUTOMATED VEHICLES

(71) Applicant: Robert Bosch GmbH, Stuttgart (DE)

(72) Inventors: Michael Gabb, Gaeufelden (DE); Ruediger-Walter Henn, Weil Der Stadt (DE)

(21) Appl. No.: 17/772,598

(22) PCT Filed: Sep. 28, 2020
(86) PCT No.: PCT/EP2020/077061

§ 371 Date: Jun. 15, 2022

(30) Foreign Application Priority Data
Nov. 4, 2019 (DE) 10 2019 216 956.2

(51) Int. Cl. G01C 21/34; B60W 60/00

(52) U.S. Cl. CPC G01C 21/3407; B60W 60/00

(57) ABSTRACT

A method and a device for determining emergency trajectories. A method and a device for operating an automated vehicle are also described.

### FIELD

The present invention relates, among other things, to a method for determining emergency trajectories and to a method for operating an automated vehicle.

### SUMMARY

A method according to an example embodiment of the present invention for determining emergency trajectories encompasses a step of receiving route data values, which represent route information of the automated vehicles, a step of determining emergency trajectories for each of the automated vehicles, as a function of the route information of the automated vehicles, the emergency trajectories each maintaining a temporal and/or local predefined minimum distance with respect to one another, and a step of transferring the emergency trajectories to the automated vehicles for operating the automated vehicles.

An automated vehicle shall be understood to mean a vehicle which is designed according to one of SAE Levels 1 through 5 (see standard SAE J3016).

A (normal and/or emergency) trajectory shall be understood to mean a predefined route for an automated vehicle which is traveled, for example, with the aid of an automated lateral and/or longitudinal control. In one specific embodiment, a trajectory represents, for example, discrete coordinate points and/or vectors, etc.

In the process, the normal trajectory, in particular, represents a connection between a starting point (for example a position of the corresponding automated vehicle at the point in time of the determination of the normal trajectory) and a destination, the determination of the normal trajectory taking place, for example, in that surroundings features (traffic density, courses of roads, intersections, other vehicles, etc.) are taken into consideration. The normal trajectory preferably represents a route for the automated vehicle which is determined by a traffic management system (for automated vehicles) with the aid of a (digital) map, taking further (automated) vehicles or other objects into consideration, a communication link between the automated vehicle and the traffic management system, for example for adapting the route to changing conditions (pedestrians, vehicle movements, etc.), being presumed during the determination.

The emergency trajectory represents a route which is used, for example, to effectuate a safe stop of the automated vehicle (without collisions with objects, further vehicles, etc.) as quickly as possible, proceeding from a position at the point in time of the occurrence of the emergency. The emergency trajectory preferably encompasses a fastest possible route into a safe area (edge area of a traffic route, parking facility, etc.).

The route information encompasses, for example, the normal trajectory and/or a (present) position of the automated vehicle, in particular, along the normal trajectory.

A temporal and/or local predefined minimum distance of the emergency trajectories to be maintained with respect to one another shall be understood to mean that these emergency trajectories either do not intersect or, if they extend at least partially in parallel, have a safety distance of, for example, several meters with respect to one another and/or that the emergency trajectories, which possibly intersect or cannot have a safety distance, are determined in such a way that the affected automated vehicles (which receive these emergency trajectories) pass the corresponding hazard area with temporal offset.

The steps of the method are preferably cyclically repeated, in particular with a predefined cycle duration, until route data values are no longer received.

This means, for example, that the route data are repeatedly received from the automated vehicles in order to determine a (present) emergency trajectory, and transfer it to the automated vehicles, for example as a function of the respective present position (along the normal trajectory).

In accordance with an example embodiment of the present invention, the method preferably additionally provides a reception of surroundings data values, the surroundings data values representing surroundings of the automated vehicles. In the process, the determination of the emergency trajectories additionally occurs as a function of the surroundings of the automated vehicles.

A reception of surroundings data values shall, for example, be understood to mean that the automated vehicles themselves (at least partially) detect these surroundings with the aid of a surroundings sensor system and transfer them for reception. In another specific embodiment, the surroundings data values are additionally or alternatively detected with the aid of an infrastructure unit (lighting equipment, traffic sign, bridge pylons, tunnel walls, etc.), encompassing a surroundings sensor system, and transfer them for reception.

A surroundings sensor system shall be understood to mean at least one video sensor and/or at least one radar sensor and/or at least one LIDAR sensor and/or at least one ultrasonic sensor and/or at least one further sensor, which is designed to detect surroundings of the automated vehicles in the form of surroundings data values. The surroundings sensor system is, in particular, designed to detect surroundings features in the surroundings (course of a road, traffic signs, roadway marking, buildings, roadway boundaries, etc.) and/or traffic objects (vehicles, bicyclists, pedestrians, etc.). In one specific embodiment of the present invention, the surroundings sensor system includes, for example, a processing unit (processor, working memory, hard disk) including suitable software and/or is connected to such a processing unit, whereby it is possible to detect and/or classify or assign these surroundings features.

A determination of the emergency trajectory shall, for example, be understood to mean that a surroundings model is created based on map data and/or route data of the automated vehicles and/or surroundings data values, and thereafter the emergency trajectories are determined with the aid of the surroundings model.

A device according to an example embodiment of the present invention (for determining emergency trajectories), in particular, a server, is configured to carry out all steps of the method of the present invention disclosed herein.

In one possible specific embodiment of the present invention, the device (for determining emergency trajectories) includes a processing unit (processor, working memory, hard disk) as well as suitable software for carrying out the method as recited in one of the method claims. For this purpose, the device includes, for example, a transceiver unit, which is designed to provide and/or to transfer and/or to receive route data values and/or surroundings data values and/or emergency trajectories (in the form of data values or in the form of signals). In one alternative specific embodiment, the device is connected to a transceiver unit with the aid of a suitable interface.

A server shall, for example, be understood to mean an individual server or a combination of servers (cloud).

Furthermore, in accordance with an example embodiment of the present invention, a computer program is provided, encompassing commands which, during the execution of the computer program by a computer, prompt the computer to carry out a method for determining emergency trajectories in accordance with the present invention. In one specific embodiment of the present invention, the computer program corresponds to the software encompassed by the device (for determining emergency trajectories).

Moreover, in accordance with an example embodiment of the present invention, a machine-readable memory medium is provided, on which the computer program is stored.

A method according to an example embodiment of the present invention for operating an automated vehicle encompasses a step of transferring route data values to an external server, the route data values representing route information, as a function of a normal trajectory of the automated vehicle, and a step of receiving an emergency trajectory from the external server, the emergency trajectory being determined with the aid of a method as recited in one of the method claims for determining emergency trajectories. The method furthermore includes a step of checking a functionality of a communication link of the automated vehicle, the communication link being at least designed to receive the emergency trajectory, and a step of operating the automated vehicle with the aid of the normal trajectory or with the aid of the emergency trajectory, as a function of the functionality of the communication link.

A functionality of the communication link of the automated vehicle shall, for example, be understood to mean the present or non-present functionality for transferring and/or receiving data values. In the process, the functionality represents, for example, one of two possible feedbacks of the communication link, in the form of data values: (1) communication link is functional; (2) communication link is not functional. The checking is carried out, for example, by carrying out an internal (software-based) analysis and/or by emitting a test signal and comparing it to a (possible) response signal.

The steps of the method are preferably cyclically repeated. In the process, the operation of the automated vehicle takes place with the aid of the normal trajectory or with the aid of the most recently received emergency trajectory.

An operation of the automated vehicle with the aid of the normal trajectory or with the aid of the most recently received emergency trajectory shall, for example, be understood to mean that the automated vehicle is moved along the corresponding trajectory with the aid of an automated lateral and/or longitudinal control. In another specific embodiment, an operation shall additionally be understood to mean an execution of a safety-enhancing assistance function (tightening the seat belts, preconditioning an airbag, adapting the seat position, etc.). An operation shall, in particular, be understood to mean that the vehicle is operated in such a way that a risk for the automated vehicle or for the occupants of the automated vehicle, for example due to a collision, is avoided or reduced as much as possible.

A device according to an example embodiment of the present invention (for operating an automated vehicle), in particular, a control unit, is configured to carry out all steps of the method in accordance with the present invention.

In one possible specific embodiment of the present invention, the device (for operating an automated vehicle) includes a processing unit (processor, working memory, hard disk) as well as suitable software for carrying out the method as recited in one of the method claims. For this purpose, the device includes, for example, a transceiver unit, which is designed to provide and/or to transfer and/or to receive route data values and/or surroundings data values and/or emergency trajectories (in the form of data values or in the form of signals). In one alternative specific embodiment, the device is connected to a transceiver unit with the aid of a suitable interface. Depending on the specific embodiment, the transceiver unit or the interface corresponds to the communication link which is at least designed to receive the emergency trajectory. Moreover, the device includes an interface for operating the automated vehicle, with the aid of which, for example, corresponding signals for a lateral and/or longitudinal control may be provided.

The methods according to the present invention advantageously achieve, among others, the object of enabling an operation of automated vehicles, for example proceeding from a traffic management center (here: server), in such a way that, even in the event of a failure of a communication link between the automated vehicles and the traffic management center, a reliable operation of the automated vehicles is made possible (for example, until the communication link is available again and/or until all involved automated vehicles have safely come to a halt (collision-free, etc.). This object is achieved with the aid of the system according to the present invention, which encompasses a device for determining emergency trajectories and a respective device for operating an automated vehicle, in that emergency trajectories are determined for each of the automated vehicles, as a function of the route information of the automated vehicles. The automated vehicles are then operated with the aid of the emergency trajectory, as a function of the functionality of the communication link which is responsible for the exchange of the relevant data. This allows these emergency trajectories to be matched to one another in such a way that no overlap or collision will occur if the communication link is (in particular, spontaneously) interrupted.

Advantageous refinements of the present invention are disclosed herein.

### BRIEF DESCRIPTION OF THE DRAWINGS

Exemplary embodiments of the present invention are shown in the figures and are described in greater detail in the following descriptions.

FIG. 1 shows one exemplary embodiment of the method according to the present invention for determining emergency trajectories in the form of a flowchart.

FIG. 2 shows one exemplary embodiment of the method according to the present invention for operating an automated vehicle in the form of a flowchart.

FIG. 3 shows an exemplary embodiment of the cooperation of the two methods in the form of a flowchart.

### DETAILED DESCRIPTION OF EXAMPLE EMBODIMENTS

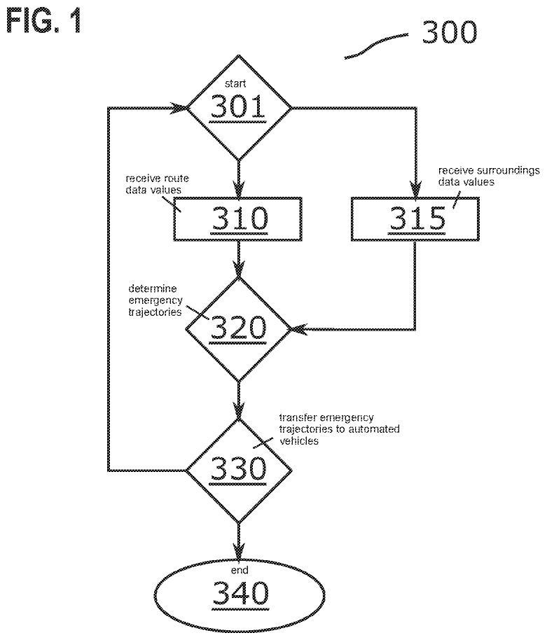

FIG. 1 shows one exemplary embodiment of a method 300 for determining 320 emergency trajectories.

In step 301, method 300 starts.

In step 310, route data values, which represent route information of automated vehicles, are received.

In one specific embodiment, step 320 follows. In an alternative specific embodiment, step 315 follows.

In step 315, surroundings data values are received, the surroundings data values representing surroundings of the automated vehicles.

In further alternative specific embodiments, first step 315 follows, and thereafter step 310, or steps 310 and 315 are at least partially carried out simultaneously.

In step 320, emergency trajectories are determined for each of the automated vehicles, as a function of the route information of the automated vehicles, in such a way that the emergency trajectories each maintain a temporal and/or local predefined minimum distance with respect to one another. In one further specific embodiment, the emergency trajectories are additionally determined as a function of the surroundings of the automated vehicles.

In step 330, the emergency trajectories are transferred to the automated vehicles, for operating the automated vehicles. In one specific embodiment, step 340 follows. In one alternative specific embodiment, steps 310, 320, 330 of method 300 are cyclically repeated, in particular with a predefined cycle duration, until route data values are no longer received.

In step 340, method 300 ends.

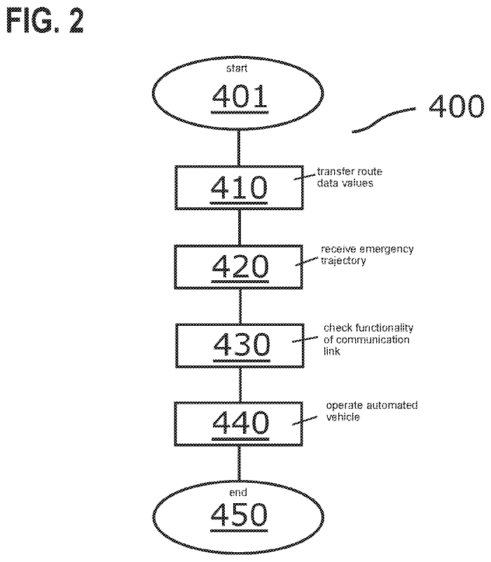

FIG. 2 shows one exemplary embodiment of a method 400 for operating 440 an automated vehicle.

In step 401, method 400 starts.

In step 410, route data values are transferred to an external server, the route data values representing route information, as a function of a normal trajectory of the automated vehicle.

In step 420, an emergency trajectory is received from the external server, the emergency trajectory being determined with the aid of one specific embodiment of method 300.

In step 430, a functionality of a communication link of the automated vehicle is checked, the communication link being at least designed to receive the emergency trajectory.

In step 440, the automated vehicle is operated with the aid of the normal trajectory or with the aid of the emergency trajectory, as a function of the functionality of the communication link. In one alternative specific embodiment, steps 410, 420, 430 of method 400 are cyclically repeated, the automated vehicle being operated with the aid of the normal trajectory or with the aid of the most recently received emergency trajectory.

In step 450, method 400 ends.

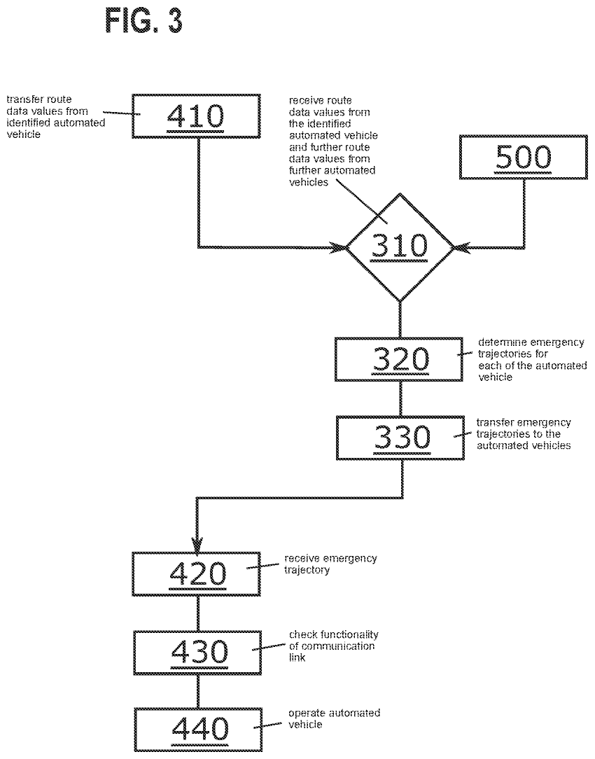

FIG. 3 shows one exemplary embodiment of the cooperation of method 300 for determining 320 emergency trajectories and of method 400 for operating 440 an (identified) automated vehicle.

In step 410, route data values are transferred from the (identified) automated vehicle to an external server, the route data values representing route information, as a function of a normal trajectory of the (identified) automated vehicle.

In step 310, the route data values from the (identified) automated vehicle as well as further route data values, which represent route information from (further) automated vehicles, are received.

In step 320, emergency trajectories (i.e., also an identified emergency trajectory for the identified automated vehicle, which in step 410 transferred its route data values) are determined for each of the automated vehicles, as a function of the route information of the automated vehicles, in such a way that the emergency trajectories in each case maintain a temporal and/or local predefined minimum distance with respect to one another.

In step 330, the emergency trajectories are transferred to the automated vehicles (i.e., the identified emergency trajectory is also transferred to the identified automated vehicle, which in step 410 transferred its route data values), for operating the automated vehicles.

In step 420, the emergency trajectory is received from the external server.

In step 430, a functionality of a communication link of the (identified) automated vehicle is checked, the communication link being at least designed to receive the emergency trajectory.

In step 440, the (identified) automated vehicle is operated with the aid of the normal trajectory or with the aid of the (identified) emergency trajectory, as a function of the functionality of the communication link.

1-9. (canceled)

10. A method for determining emergency trajectories, comprising the following steps:
receiving route data values, which represent route information of automated vehicles;
determining emergency trajectories for each of the automated vehicles, as a function of the route information of the automated vehicles, the emergency trajectories each maintaining a temporal and/or local predefined minimum distance with respect to one another; and
transferring the emergency trajectories to the automated vehicles, for operating the automated vehicles.

11. The method as recited in claim 10, wherein the steps of the method are cyclically repeated with a predefined cycle duration, until route data values are no longer received.

12. The method as recited in claim 10, wherein further comprising:
receiving surroundings data values, the surroundings data values representing surroundings of the automated vehicles, wherein the determination of the emergency trajectories additionally taking place as a function of the surroundings of the automated vehicles.

13. A device, comprising:
a server configured to determine emergency trajectories, the server configured to:
receive route data values, which represent route information of automated vehicles;
determine emergency trajectories for each of the automated vehicles, as a function of the route information of the automated vehicles, the emergency trajectories each maintaining a temporal and/or local predefined minimum distance with respect to one another; and
transfer the emergency trajectories to the automated vehicles, for operating the automated vehicles.

14. A non-transitory machine-readable memory medium on which is stored a computer program for determining emergency trajectories, the computer program, when executed by a computer, causing the computer to perform the following steps:
receiving route data values, which represent route information of automated vehicles;
determining emergency trajectories for each of the automated vehicles, as a function of the route information of the automated vehicles, the emergency trajectories each maintaining a temporal and/or local predefined minimum distance with respect to one another; and
transferring the emergency trajectories to the automated vehicles, for operating the automated vehicles.

15. A method for operating an automated vehicle, comprising the following steps:
transferring route data values to an external server, the route data values representing route information, as a function of a normal trajectory of the automated vehicle;
receiving an emergency trajectory from the external server, the emergency trajectory being determined by the external service by performing:
receiving the route data values, and further route data values from other automated vehicles which represent route information of the other automated vehicles,
determining emergency trajectories for each of the automated vehicles, as a function of the route information of the automated vehicles, the emergency trajectories each maintaining a temporal and/or local predefined minimum distance with respect to one another, and
transferring the emergency trajectories to the automated vehicles, for operating the automated vehicles;
checking a functionality of a communication link of the automated vehicle, the communication link being at least configured to receive the emergency trajectory; and
operating the automated vehicle using a normal trajectory or using the emergency trajectory, as a function of the functionality of the communication link.

16. The method as recited in claim 15, wherein the steps of the method are cyclically repeated, and the operation of the automated vehicle takes place using a normal trajectory or using a most recently received emergency trajectory.

17. A device, comprising:
a control unit configured to operate an automated vehicle, the control unit configured to:
transfer route data values to an external server, the route data values representing route information, as a function of a normal trajectory of the automated vehicle;
receive an emergency trajectory from the external server, the external service configured to:
receive the route data values, and further route data values from other automated vehicles which represent route information of the other automated vehicles,
determine emergency trajectories for each of the automated vehicles, as a function of the route information of the automated vehicles, the emergency trajectories each maintaining a temporal and/or local predefined minimum distance with respect to one another, and
transfer the emergency trajectories to the automated vehicles, for operating the automated vehicles;
check a functionality of a communication link of the automated vehicle, the communication link being at least configured to receive the emergency trajectory; and
operate the automated vehicle using a normal trajectory or using the emergency trajectory, as a function of the functionality of the communication link.
